(19) United States
(12) Patent Application Publication
(10) Pub. No.: US 2013/0194935 A1
(43) Pub. Date: Aug. 1, 2013

(54) CIRCUIT TESTING ARRANGEMENT FOR SERIALISER/DESERIALISER

(71) Applicant: Texas Instruments Incorporated, Dallas, TX (US)

(72) Inventor: Iain Robertson, Bedford (GB)

(73) Assignee: TEXAS INSTRUMENTS INCORPORATED, Dallas, TX (US)

(21) Appl. No.: 13/755,703

(22) Filed: Jan. 31, 2013

(30) Foreign Application Priority Data
Jan. 31, 2012 (GB) 1201596.2

(51) Int. Cl. H04B 3/46

(52) U.S. Cl. CPC H04B 3/46
USPC 370/248

(57) ABSTRACT

The present invention relates to a test arrangement for a serdes ip block and in particular provides a serdes test chip comprising a serdes instance to be tested and further instances of said serdes, said further instances constitution a data transfer path for data with which said serdes is to be tested. The data may come from a programmable gate array and enables the testing of data transfer schemes yet to be embodied in an integrated circuit ip block.

This application claims priority under 35 USC §119(e)(1) of European Application Number GB 1201596.2, filed on Jan. 31, 2012.

The present invention relates to circuit testing and in particular the testing of high speed data transfer circuits such as serdes (serialiser/deserialiser) which transfer, for example, parallel data in high speed serial fashion. These are leading edge circuits which are customarily tested in isolation on test chips before being released for incorporation in larger or system integrated circuits.

### BACKGROUND

SerDes are complex, mixed signal IP blocks that need to be implemented on test silicon as part of the process of refining them towards a production-worthy product. As well as verifying the performance of the SerDes itself, it is highly desirable to be able to ensure that the SerDes works correctly in a larger system, and in particular that it interacts correctly with the digital blocks most closely associated with it. In the Ethernet world, the block which sits behind the SerDes is known as the Physical Coding Sublayer, or PCS, and all standards have a block that performs similar functions, though they may have different nomenclature for what this block is called.

The PCS is a digital block typically implemented as a soft IP. One way to test that the SerDes and PCS work together might be to put the PCS in the testchip. However, there are numerous reasons why this is not ideal different standards require different PCS blocks; bugs in the PCS cannot easily be worked around without respining the testchip; the PCS block(s) may not be available when the testchip needs to be made different developer, not the semiconductor vendor); and such like.

A better solution could be to provide an interface on the testchip so that the parallel data side of the SerDes on the testchip could be connected to a PCS implemented in an FPGA (gate array device). This overcomes the issues above: one can mix and match different PCS implementations in the FPGA with the SerDes in the testchip; one can fix bugs or enhance the PCS quickly by reprogramming the FPGA; one does not have to have the PCS implementation complete when producing the testchip.

However, in order to do this, one would need a suitable interface on the testchip to talk to the FPGA, and hereby lies an issue. This interface needs to have quite high bandwidth, and in the past has been implemented using a DDR (double data rate) interface. This has been problematic because the SerDes is often one of the first pieces of IP in a given semiconductor technology node, and the DDR macros required for the DDR interface are not available, or are themselves in their testchip/debug phase. Either way, they're not available and robust. With newer SerDes running at ever higher data rates, this is even more of an issue. For example, for a leading edge SerDes which runs at 17 Gbps, one would need a 20-bit DDR at 850 Mbps per pin. This is pushing DDR technology, and takes a lot of pins.

### SUMMARY

The present invention provides a solution to at least these problems by for example using another instance or instances of the SerDes itself to communicate with the FPGA.

### DESCRIPTION OF DRAWINGS

An embodiment of the present invention will now be described, by way of example only and with reference to the accompanying diagrammatic drawings of which:

FIG. 1 is a high level diagram; and

FIG. 2 illustrates the multiplexing function of the embodiment.

### DETAILED DESCRIPTION

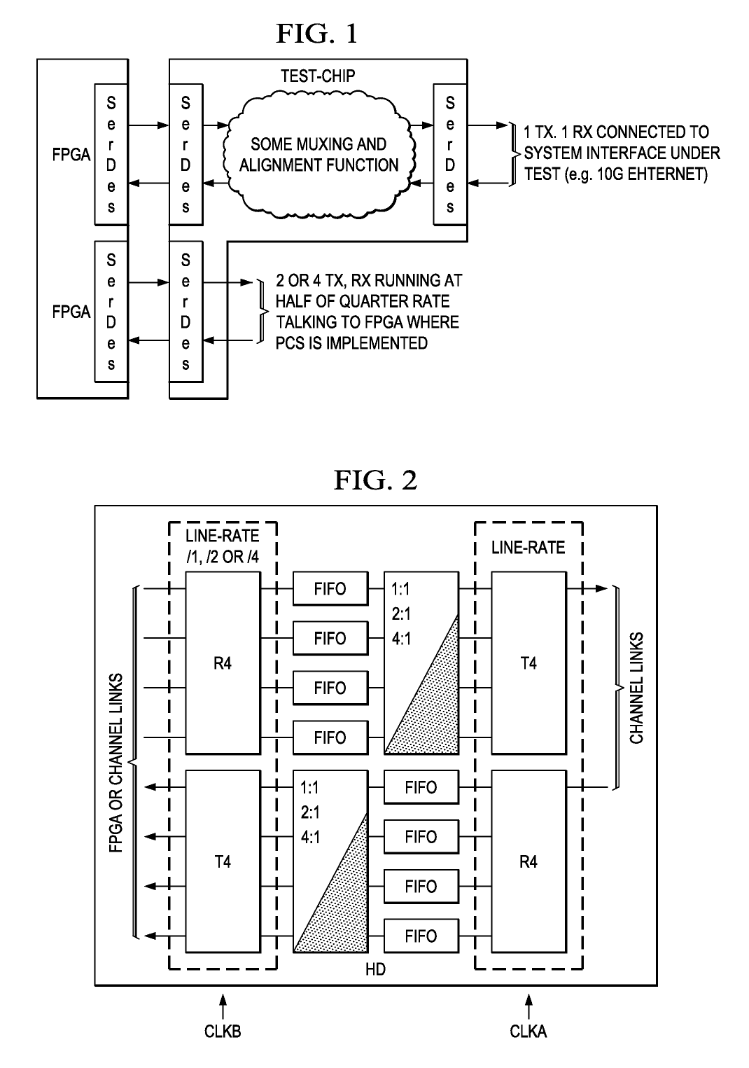

FPGAs with embedded SerDes are commonplace these days. However, these embedded SerDes are significantly slower than the SerDes in a testchip (i.e. they are mature technology). Therefore, it would be necessary to use many such SerDes on the FPGA in concert with instances of the serdes under test on the test chip. FIG. 1 is an exemplary high level diagram of an embodiment of the present invention.

The SerDes of interest (under test) is on the right, the PCS is in the FPGA on the left. Data to/from the SerDes on the right is striped across 2 or 4 lanes on the left.

The tricky part here is how to convert between one lane and 2 or 4 lanes at half or quarter of the rate, in a manner which is not dependent on the data format of any particular standard and does not require lots of complex hardware in the testchip.

The basic muxing function of the present embodiment is illustrated in FIG. 2. The boxes marked 1:1 2:1 4:1 are the added muxing functionality and associated control required. Everything else required would have been in the testchip in any event.

Even when not using the novel FPGA interface arrangement of the present invention, it is common to use two SerDes macros on the test chip and provide FIFO architecture to cross clock domains. For example, in test data is sent from a BERT (e.g. a known bit error rate tester) to a SerDes receiver, through FIFOs to an associated SerDes transmitter and back to the BERT. For this configuration, one uses the 1:1 muxing option of the present embodiment. When the BERT is replaced by an FPGA in accordance with the principles of the present invention, one would send data from the FPGA to 2 or 4 SerDes receivers, and then use the 2:1 or 4:1 muxing option to output that data on a single SerDes transmitter on the test side. Externally it might then go through some backplane or other media, and get looped back to a single receiver, thence through a 1:2 or 1:4 demux, and back to the FPGA. The muxing and demuxing functions implemented in the testchip are also implemented in the FPGA. So for example, the data flow would be:

From the FPGA: Single data stream in the FPGA->demux to 2 or 4 data streams->send to testchip->mux back to one data stream->output to channel;

To the FPGA: Single data stream input to the testchip->demux to 2 or 4 data streams->send to FPGA->mux back to one data stream.

The 1:2 or 1:4 demux function is trivial as a single datastream at a particular data rate is being distributed to 2 or 4 lanes at half or a quarter of the rate. For example, assuming a 16-bit datapath, simply send the odd numbered 16-bit words to one lane and the even numbered 16 bit words to the other (for a 1:2 demux).

The 2:1 or 4:1 mux function is more tricky, because the data has arrived on multiple lanes which have independent clock recovery, and needs to be reassembled in the right order, and with the right word alignment. There are two things to consider: word alignment of the data received on each lane and inter-lane alignment so data from the different receiving lanes is recombined into a single stream in the right order.

How to use the existing SerDes pattern generation and verification features to achieve this in accord with the present invention is now described. The basic idea is to use these patterns as an initial training phase to set up the correct alignment before switching to the appropriate data stream for whichever standard is being tested.

Using the 2:1 case as an example. The 4:1 case is a simple extension of the same principles.

As previously discussed, data is being sent even words via one serDes, odd words via the other. When recovered at the receiving end, these two data streams cannot simply be muxed back together (odd, even, odd, even, etc) without first ensuring it is aligned correctly. The basic technique is for example follows:

Generate a test pattern in the the FPGA;

Demux the pattern as described above, and send it to the testchip;

Recover the data in the testchip, and mux the two streams back together (odd, even, odd, even, etc.);

Configure the line-side SerDes on the testchip in internal loopback, and use its internal pattern verifier to check that the recombined pattern is correct;

Use an iterative process to adjust the word and lane alignment until the pattern verifier shows the pattern is correct;

Switch out of internal loopback, and start sending application data from the FPGA.

The first step is to achieve word alignment. Start by sending a series of clock patterns. The key here is that the even and odd words are the same, so it does not matter if the inter-lane alignment is wrong. Consider this example:

Send 1010 1010 1010 1010. After recovering the data and recombining into a single stream, there are two possible outcomes:
Data is correctly aligned, or
Alternate words are mis-aligned by 1 bit: 1010 1010 1010 1010 followed by 0101 0101 0101 0101, etc.

If the former, the pattern verifier will pass, and if the latter it will fail. In the case of failure, use the existing serdes realignment scheme ‘jog capability’ to adjust the alignment of one of the receiving SerDes by 1 bit. The pattern will then start to pass testing verification;

Change to 1100 1100 1100 1100. This time there are 4 possible alignments. 0, 1, 2 or 3 jogs may be required on one of the SerDes receivers in order to get the pattern to pass;

Repeat the process, first with 1111 0000 1111 0000, and then with 1111 1111 0000 0000. At this point, both receiving SerDes have the same word alignment.

However, because the data from the two receiving SerDes are using separate recovered clocks, and are passed through a clock domain crossing FIFO before being recombined into the single clock domain of the line-side SerDes (test) transmitter, this is not yet sufficient to ensure the data stream is correct. For example, consider the data stream to have been demuxed into words numbered A0, A1, B0, B1, C0, C1, etc. with all the odd words sent via one SerDes link, and all the even words via the other. After the alignment process above, the recombined data stream may be correct, or it may be offset by one word as a result of the clock domain crossing (e.g. A1, A0, B1, B0, C1, C0, etc.). This can be corrected for by adjusting the FIFOs to add or delete one word. This approach is well known in the art for inter-lane alignment, but generally relies on some form of alignment symbol in the data stream that can be used to identify the amount of mis-alignment that needs to be corrected for.

In this example, the same effect is achieved using an extension of the pattern verification technique described above, by switching from a clock pattern to a PRBS (pseudo random) pattern after the word alignment process is complete. The key difference is that with the word alignment process, all the words (A0, A1, B0, B1, etc.) are the same, but with a PRBS they are not. When aligning 2 lanes, there are 3 possible alignments:
Both lanes aligned;
Even lane is ahead of the odd lane;
Odd lane is ahead of the even lane.

If they are aligned, the PRBS verifier will pass. If they are not aligned, there is no way of knowing which of the other cases it is, so just try them both. The full sequence would be something like this:
Advance even FIFO by 1;
If still fail, retard even FIFO by 2.

Having described my invention and exemplary embodiments thereof, what I claim is set forth in the appended claims.

1. A serdes test chip comprising a serdes instance to be tested and further instances of said serdes, said further instances constituting a data transfer path for data with which said serdes is tested.

2. A test chip as claimed in claim 1 wherein the data from said further instances is multiplexed together to provide said data with which said serdes is tested.

3. A test chip as claimed in claim 2 including circuitry for realigning data from said further instances before multiplexing.

4. A test chip as claimed in claim 1 including two instances of said serdes for testing via loopback.

5. A test chip as claimed in claim 1 enabling testing of data transfer schemes yet to be embodied in an integrated circuit ip block.

6. A serdes test arrangement including a test chip as claimed in claim 1.

7. The arrangement of claim 6 including a pattern generator, said data path being part of an interface with said pattern generator.

8. The arrangement of claim 7 wherein the pattern generator is embodied in a programmable gate array.

9. The arrangement of claim 7 including sufficient instances of serdes that are slower speed than said serdes to be tested to transfer of data via said data path to enable testing of said serdes to be tested at faster speed.
